(19) United States
(12) Patent Application Publication
(10) Pub. No.: US 2010/0204977 A1
(43) Pub. Date: Aug. 12, 2010

(54) Real-time translation system that automatically distinguishes multiple languages and the method thereof

(75) Inventors: Chaucer Chiu, Taipei (TW); Tao Zhou, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/320,912

(22) Filed: Feb. 9, 2009

(51) Int. Cl. G06F 17/28

(52) U.S. Cl. 704/2

(57) ABSTRACT

A real-time translation system that automatically distinguishes multiple languages and the method thereof are provided. This solves the problem of being unable to translate a document containing multiple languages. Each sentence in the document is decomposed into multiple words and the language of each of which is determined. The languages of the words in the context are then used to adjust the translation. The mechanism can achieve the effect of precision translation.

### BACKGROUND OF THE INVENTION

1. Field of Invention

The invention relates to a real-time translation system and the method thereof. More particularly, the invention relates to a translation system that automatically distinguishes multiple languages and the method thereof.

2. Related Art

In recent years, with rapid development in computers and Internet, documents containing multiple languages have become very popular. There are many translation programs that can translate various languages. Generally speaking, before using the translation software, the user has to specify the source language to translate and the target language to be translated into. If the user does not know which language to translate, then no translation can be done. Even if the user knows the source language to translate, such programs are still inconvenient in use because the user has to set conditions beforehand.

In view of the above-mentioned inconvenience in operations, some vendors propose the method of using the code to determine the source language, replacing the method of setting the source language by hand. However, this method is not suitable for western languages that use the same alphabets, such as English, French, German, etc. Take the word ‘apple’ as an example. The translation program cannot determine whether it is English or French from its code. In this case, it may happen that the French vocabulary database is used to translate English words, or words simply cannot be translated. Therefore, the methods in the prior art have the problem of being unable to translate documents with multiple languages.

It is thus imperative to provide a better technique to properly translate documents containing multiple languages.

### SUMMARY OF THE INVENTION

In view of the foregoing, the invention discloses a real-time translation system that automatically distinguishes multiple languages and the method thereof.

The disclosed real-time translation system includes: a translation database, a loading module, an analyzing module, and a translating module. The translation database stores translation words according to the language. The loading module loads a sentence to translate and decomposes the sentence into words to translate according to dividing rules. Each word to translate corresponds to a language parameter. The analyzing module compares the word to translate with the translation words in the language. When there is a match, the language parameter of the word to translate is adjusted according to the language. The translating module follows the language parameter of the word to translate and look for the word in the corresponding language.

The disclosed real-time translation method that automatically distinguishes multiple languages includes the steps of: establishing translation words according to languages; loading in a sentence to translate and decomposing the sentence into words to translate according to dividing rules, each of the words to translate having a corresponding language parameter; comparing the words to translate with the translation words in the languages and adjusting the language parameter of the words to translate according to the language when there is a match; and looking up the words to translate in the corresponding language according to the language parameter and displaying the translation word.

The disclosed system and method differ from the prior art in that each sentence in a document is decomposed into several words to translate. The invention determines the language of each word in order to adjust the translation according to the context.

Using the disclosed technique, the invention can achieve precision translations.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed real-time translation system that automatically distinguishes multiple languages;

FIG. 2 is a flowchart of the disclosed real-time translation method that automatically distinguishes multiple languages;

FIG. 3 is a schematic view of the first embodiment according to the invention;

FIG. 4 is a schematic view of the second embodiment according to the invention; and

FIG. 5 is a schematic view of the setting window in accord with the invention.

### DETAILED DESCRIPTION OF THE INVENTION

The present invention will be apparent from the following detailed description, which proceeds with reference to the accompanying drawings, wherein the same references relate to the same elements.

Those Chinese characters shown in the drawings are just mentioned for describing the embodiments and are substantially irrelevant to any technical matters.

Before describing the disclosed translation system and method that automatically distinguish multiple languages, terms used in the specification are first defined as follows. The sentence to translate consists of at least one word to translate. For example, when the sentence to translate is ‘This is an apple.’, the words to translate are ‘This’, ‘is’, ‘an’, and ‘apple’.

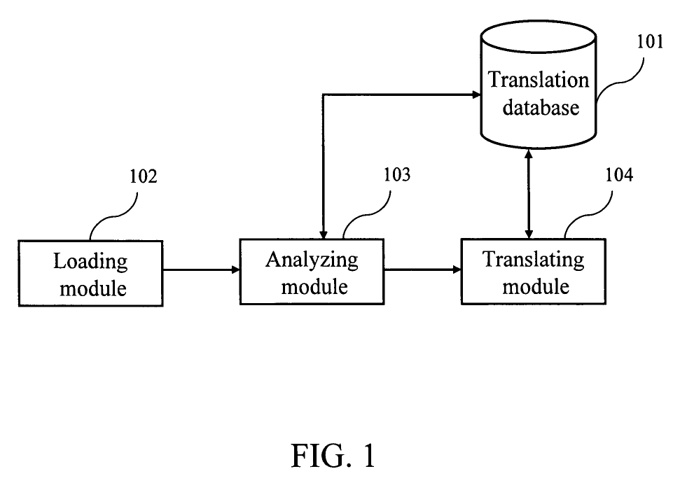

First, FIG. 1 is a block diagram of the disclosed real-time translation system that automatically distinguishes multiple languages. The system includes a translation database 101, a loading module 102, an analyzing module 103, and a translating module 104. The translation database 101 stores translation words of different languages. The different languages referred herein are languages using same alphabets, such as English, French, German, Italian, etc. More explicitly, translation words in English are stored in English; those in French are stored in French; and so on. This enables the invention to look up translation words according to different languages.

The loading module 102 loads in a sentence to translate and decomposes the sentence into words to translate according to some dividing rules. Each of the words to translate has a corresponding language parameter. The sentence can be loaded by loading in a document or cursor-selecting text in a window. The dividing rules are settings for decomposing the sentence according to space and/or punctuation. For example, suppose the sentence to translate is ‘This is an apple.’, then it can be decomposed into ‘This’, ‘is’, ‘an’, and ‘apple’ according to the dividing rule of space.

Besides, the language parameter can be used to store the priority in language for the word to translate. For example, suppose the word to translate is ‘apple’. Both English and French have a translation word corresponding to such a word. When it is compared in the translation database 101, if the corresponding translation word is first found in English then in French, then the language parameter records English as the first priority and French as the second. If other languages also have the word ‘apple’, then they are recorded as the third priority and so on. How to know whether various languages have the same translation word for the word to translate will be detailed later. In addition, the language parameter can be used to record the language type of the word to translate. That is, the language parameter only records one language instead of several languages with priorities. In practice, the usage frequency of each translation word can be associated with a predetermined frequency parameter in advance. The predetermined frequency parameter is then used to set and adjust the language parameter. For example, suppose the translation word ‘apple’ in English and French has value ‘3’ and ‘1’ for the frequency parameter, respectively. When making comparisons of translation words, ‘apple’ is found in both English and French. In this case, the frequency parameter value is used to set and adjust the language parameter. In this example, the language of the translation word with a larger value of the frequency parameter (e.g., English) is recorded in the language parameter. The invention does not restrict the recording format and adjusting method of the language parameter. In the following, a first embodiment and a second embodiment along with the companying figures are used to demonstrate different recording formats and adjusting methods.

The analyzing module 103 compares the word to translate with translation words in different languages. When there is a match, the language type is used to adjust the language parameter of the word to translate. As mentioned before, the invention knows whether each language has a translation word identical to the word to translate. The analyzing module 103 compares the word to translate with the translations words of different languages. Take the word ‘apple’ as an example. It is compared with all translation words of different languages in the translation database 101. When there is a match, the language type is sued to adjust the language parameter of the word to translate. For example, when the word to translate matches with a translation word in English, its language parameter uses English as its first priority. Afterwards, when the word to translate also matches with a translation word in French, its language parameter uses French as the second priority. This process continues until the comparison is done.

The adjustment of the language parameter is further done according to the language parameters of its preivous word to translate and its next word to translate. For example, suppose the language parameter of the previous word to translate has English as its first priority and that of the next word to translate also has English as its first priority, then the language parameter of the current word to translate is adjusted so that English has the first priority. If the previous word to translate and the next word to translate are of different languages (i.e., first priority in different languages), then the language parameter of the current word to translate is not adjusted. It should be mentioned that the invention does not restrict the possibility of making adjustments merely using the previous and next words to translate. In practice, the invention can also use the language parameter of the entire sentence to make the adjustment. For example, if the entire sentence has five words to translate using English as their first priority and three words to translate using French as their first priority, then the language parameters of all words to translate are modified to use English as their first priority. It should be noted that during the adjusting process, the language parameter can only use a language that it has as its first priority. In other words, if the language parameter of a word to translate only has French as its first priority and no other candidate language, then French is kept as its first priority.

As mentioned before, each of the translation words is associated with a frequency parameter to record the usage frequency of each of them in the corresponding language. Therefore, the frequency parameter can be used to adjust the language parameter of the word to translate. For example, suppose the frequency parameter of the English translation word ‘apple’ (e.g., value ‘2’) is greater than the French translation word ‘apple’ (e.g., value ‘1’). If the previous word to translate and the next word to translate have the language parameters of English and French, respectively, the frequency parameter of the translation word is used to make adjustments. That is, when there is no way to determine the language of the word to translate according to the language parameters of its previous and next words to translate, then a translation word with a larger usage parameter (e.g., the English translation word ‘apple’) is used for translation. Alternatively, English is used as the first priority in the language parameter of the word to translate ‘apple’, and French is used as the second priority.

The translating module 104 looks up the word to translate in the language corresponding to the language parameter and displays it. For example, the word to translate ‘apple’ has English and French as its first priority and second priority in the language parameter. In this case, it is looked up in English of the translation database 101.

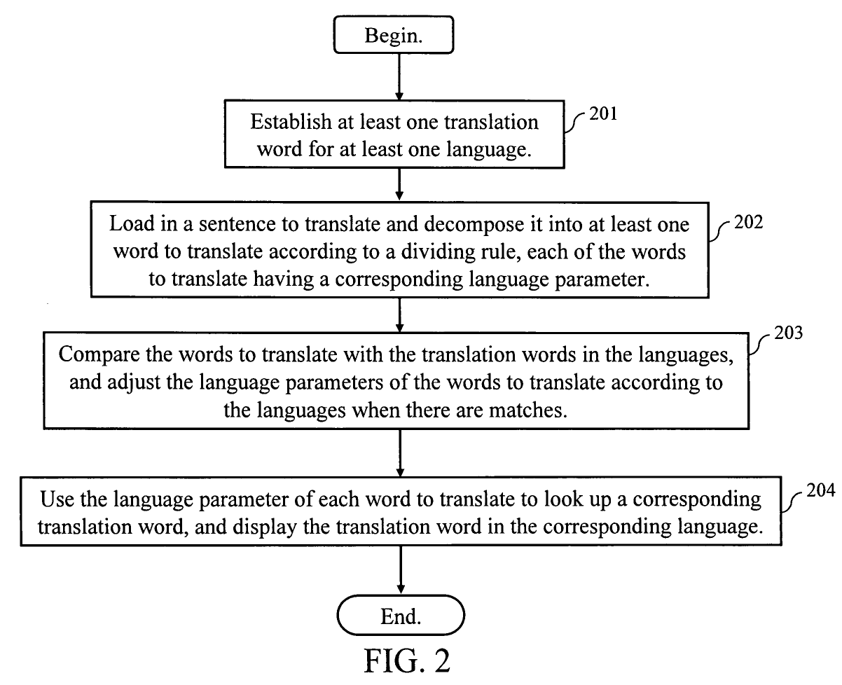

FIG. 2 is a flowchart of the disclosed real-time translation method that automatically distinguishes multiple languages. The method includes the following steps. Step 201 establishes translation words according to languages. Step 202 loads in a sentence to translate and decomposes it into words to translate according to dividing rules, each of the words to translate having a corresponding language parameter. Step 203 compares the word to translate with the translation words in the corresponding language and, when there is a match, adjusts the language parameter thereof according to the language. In step 204, translation words are looked up in the language corresponding to the language parameters thereof and then displayed. Through the above-mentioned steps, each sentence in a document is decomposed into several words. The language of each word is determined. The translation is then done according to the language parameters of the words in the context. This method increases the precision in translating a document with multiple languages.

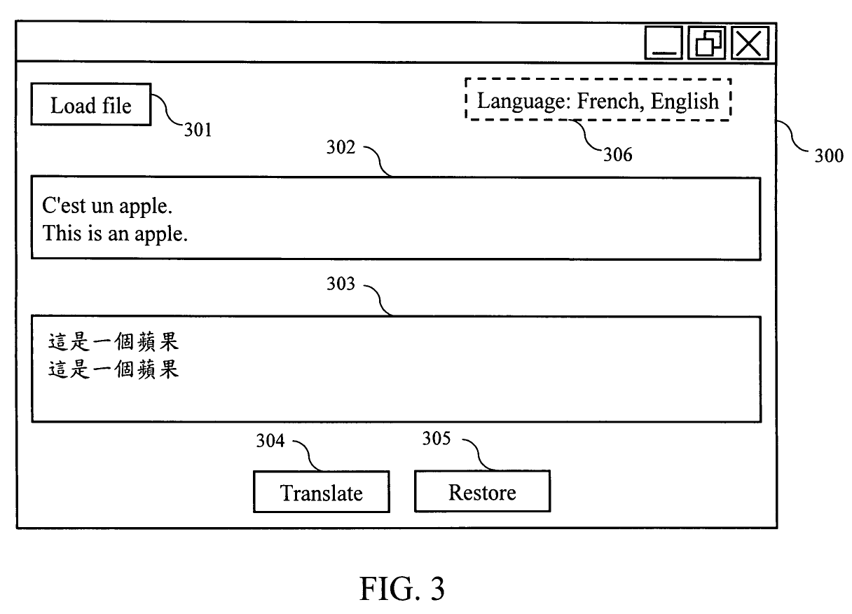

Please refer to FIGS. 3 to 5 for an embodiment of the invention. FIG. 3 is a schematic view of the first embodiment of the invention. When a user wants to translate a document containing multiple languages, he/she can click the loading element 301 in the translation window 300 to load in the document to translate. The content of the loaded document is displayed in the entering field of sentence to translate 302. For example, the document content is ‘C'est un apple’. ‘This is an apple.’. After the user clicks the translating element 304, the loading module 102 loads in the sentence to translate. The document content is then decomposes into words to translate (e.g., ‘C'est’, ‘un’, ‘apple’, etc) according to predetermined dividing rules (e.g., using spaces and punctuations).

Afterwards, the analyzing module 103 compares a word to translate (e.g., ‘C'est’, ‘un’, and ‘apple’) with the translation words of all languages in the translation database 101. When there is a match, the corresponding language is used to adjust the language parameter of the word. In this example, the language parameter of the word to translate ‘C'est’ has French as its first priority. This is because ‘C'est’ is only found in French translation words. The language parameter of the word to translate ‘un’ has French as its first priority and English as the second priority. This is because its previous word to translate ‘C'est’ is purely French. The comparison can start from French translation words. Once there is a match, the first priority is recorded to be French. Later on, the word to translate ‘un’ is also found in English translation words. English is thus recorded as the second priority in the language parameter. The language parameter of ‘apple’ has English as its first priority ad French as the second priority. This is because its previous word to translate ‘un’ belongs to several languages. The word to translate ‘apple’ is thus compared with the translation words of all languages according to a predetermined order. Sine in this sentence, the language parameter of the word to translate ‘C'est’ only has French as its first priority and no other language, its language parameter remains unchanged. For the word to translate ‘un’, both its previous and next words to translate have French in the language parameters (first and second priorities, respectively). Consequently, the language parameter of the word to translate ‘un’ remains using French as its first priority and English as the second. When adjusting the language parameter of the word to translate ‘apple’, the first priority in the language parameter of its previous word to translate ‘un’ has been determined to be French. Therefore, its own language parameter is adjusted so that French becomes the first priority and English the second.

After finishing the language parameter adjustments of all words to translate (so that the first priority is French), the translating module 104 uses the language parameter of these words to translate (the one with the first priority) to look for them in the corresponding language (e.g., French). The result is then displayed. In the current example, the French translation words corresponding to the words to translate ‘C'est’, ‘un’, and ‘apple’ are looked up in the translation database 101. They are ‘This is’, ‘a’, and ‘apple’, respectively. They are displayed in the translation result displaying field 303. It should be mentioned that the first priority, second priority, and so on in the language parameter are used only when adjusting the language parameters. After the adjustment is done, the translating module 104 only uses the first priority to look for words to translate in the corresponding language.

Afterwards, the same method is applied to another sentence to translate. For example, ‘This is an apple.’ is decomposed into ‘This’, ‘is’, ‘an’, and ‘apple’. Since the processing detail is the same as the sentence ‘C'est un apple’, it is not repeated here again. The only difference is that the language parameters of the words to translate (i.e., ‘This’, ‘is’, ‘an’, and ‘apple’) all use English as the first priority. The translating module 104 looks for the words to translate ‘This’, ‘is’, ‘an’, and ‘apple’ in the translation database 101 and finds the corresponding translation words [symbol] and [symbol] . These translation words are reorganized according to the semantic rules contained in the translation software. Up to this point, the translation of the sentence to translate is done. The user can click a restoring element 305 to restore to the state before the translation. He or she can even display the language types (e.g., English and French) contained in the document in a language displaying field 306.

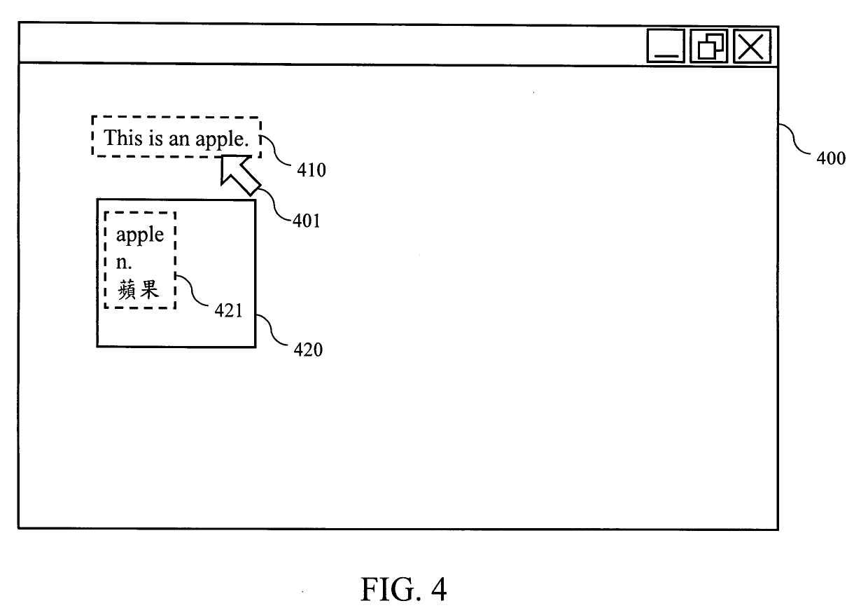

FIG. 4 is a schematic view of the second embodiment of the invention. When a user opens a displaying window 400 of a normal application program, he/she can mark words by dragging the cursor 401. The marked words (‘This is an apple.’) can be extracted by pressing a function key and assigned as a sentence to translate 410. Since the extraction of marked words belongs to the prior art, it is not further described herein. Afterwards, the loading module 102 loads in the extracted sentence to translate 410. According to some dividing rules (e.g., spaces and punctuations), the sentence to translate is decomposed into several words to translate, such as ‘This’, ‘is’, ‘an’, and ‘apple’. Each of the words to translate has a corresponding language parameter.

Afterwards, the analyzing module 103 compares all the words to translate with all the translation words in the translation database 101. When there is a match, the language of the translation word is used to adjust the language parameter of the corresponding word to translate. As mentioned before, the adjustment of the language parameter of each word to translate is not limited to using the language parameters of its previous and next words to translate. To distinguish from the first embodiment, in the second embodiment the analyzing module 103 further records the languages of the words to translate (i.e., ‘This’, ‘is’, ‘an’, and ‘apple’) in a table (not shown). For example, suppose the words to translate ‘This’, ‘is’, and ‘an’ can be found in the English translation words, and the word to translate ‘apple’ can be found in both English and French translation words. The table then records as: ‘This: English’; ‘is: English’; ‘an: English’; and ‘apple: English, French’. According to this table, English is set as the language parameter of ‘This’, ‘is’, and ‘an’. Although the word to translate ‘apple’ is found in both English and French, English is set as the language parameter because it appears at a higher frequency in the table. This completes the adjustment of the language parameters of the words to translate.

After the language parameter adjustment is done, the translating module 104 follows the language parameter of the words to translate to search for the translation words in the corresponding language in the translation database 101. Afterwards, a floating window 420 displays the translation word 421 corresponding to the word to translate ‘apple’ where the cursor 401 is located. Moreover, semantic rules may even be used to reorganize the words to translate. The translation result of the entire sentence is then displayed in the floating window 420 (not shown). Since the technique of using semantic rules to reorganize the translation words belongs to the prior art, it is not repeated herein.

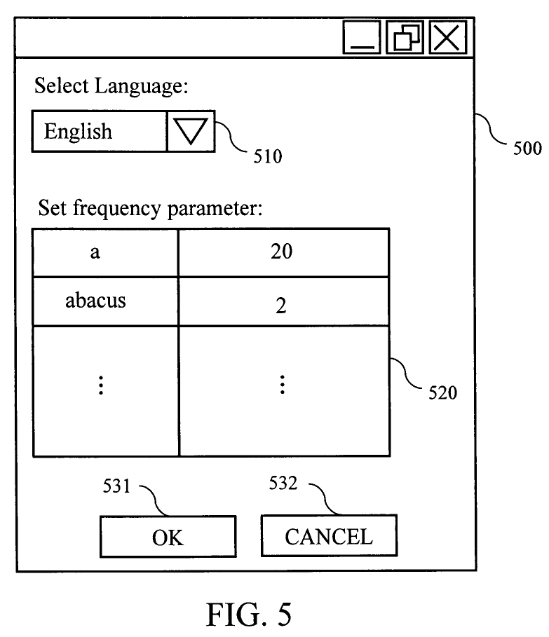

FIG. 5 is a schematic view of the frequency setting window in accord with the invention. When the user wants to set commonly used translation words, he/she can achieve that by setting the frequency parameters of the translation words. The language (e.g., English) is determined using a language selecting element 510 in the setting window 500. After the user selects the language, a frequency parameter setting field 520 loads in the translation word and the corresponding frequency parameter for the user to modify settings. In this case, the user can give a larger numerical value (e.g., ‘20’) to the commonly used translation word (e.g., ‘a’), and click an OK element 531 to save the setting or click a CANCEL element 532 to cancel the setting. It should be emphasized that the invention does not restrict the type and number of elements in the setting window 500. Any element that can change the frequency parameter can be used without departing from the scope of the invention.

In summary, the invention differs from the prior art in that the sentence in a document is first decomposed into several words. The language of each word is determined. The translation is then adjusted according to the languages of the words in the context. The disclosed technique can automatically translate a document containing multiple languages, solving problems in the prior art and increasing the precision in translation.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A real-time translation system that automatically distinguishes multiple languages, comprising:
a translation database, which stores at least one translation word in at least one language;
a loading module, which loads in a sentence to translate and decomposes the sentence to translate into at least one word to translate according to a dividing rule, each of the words to translate having a corresponding language parameter;
an analyzing module, which compares the words to translate with the translation words in the languages and adjusts the corresponding language parameter when there is a match; and
a translating module, which uses the language parameter of each of the words to translate to look up a translation word in the corresponding language and displays the translation word.

2. The real-time translation system that automatically distinguishes multiple languages of claim 1, wherein the languages are those language using the same alphabets.

3. The real-time translation system that automatically distinguishes multiple languages of claim 1, wherein the language parameter records the priorities of the languages.

4. The real-time translation system that automatically distinguishes multiple languages of claim 1, wherein the adjustment of the language parameter is performed according to the language parameters of the previous and next words to translate.

5. The real-time translation system that automatically distinguishes multiple languages of claim 1, wherein each of the translation words has a frequency parameter recording to the usage frequency of it in the languages.

6. A real-time translation method that automatically distinguishes multiple languages, comprising the steps of:
establishing at least one translation word for at least one language;
loading in a sentence to translate and decomposing the sentence to translate into at least one word to translate according to a dividing rule, each of the words to translate having a corresponding language parameter;
comparing the words to translate with the translation words in the languages and adjusting the corresponding language parameter when there is a match; and
using the language parameter of each of the words to translate to look up a translation word in the corresponding language and displaying the translation word.

7. The real-time translation method that automatically distinguishes multiple languages of claim 6, wherein the languages are those language using the same alphabets.

8. The real-time translation method that automatically distinguishes multiple languages of claim 6, wherein the language parameter records the priorities of the languages.

9. The real-time translation method that automatically distinguishes multiple languages of claim 6, wherein the adjustment of the language parameter is performed according to the language parameters of the previous and next words to translate.

10. The real-time translation method that automatically distinguishes multiple languages of claim 6, wherein each of the translation words has a frequency parameter recording to the usage frequency of it in the languages.
